(19) United States
(12) Patent Application Publication
(10) Pub. No.: US 2016/0037138 A1
(43) Pub. Date: Feb. 4, 2016

(54) Dynamic System and Method for Detecting Drowning

(71) Applicant: Danny UDLER, Nesher (IL)

(72) Inventor: Danny UDLER, Nesher (IL)

(21) Appl. No.: 14/817,405

(22) Filed: Aug. 4, 2015

Related U.S. Application Data
(60) Provisional application No. 62/032,715, filed on Aug. 4, 2014.

(51) Int. Cl. H04N 7/18; H04N 5/225; G06K 9/00

(52) U.S. Cl. CPC H04N 7/185; G06K 9/00711; H04N 5/2251; G06K 2009/00738

(57) ABSTRACT

The present invention discloses a dynamic system for identifying and alerting drowning in a pool. The system comprised of: at least one camera movable along a rail installed within the pool underwater, at least one controller for determining camera movement based on analyzing image captured by said camera, such that the camera viewing area is not distracted, identifying and alerting drowning pattern by analyzing captured images by said movable camera.

### BACKGROUND

The present invention relates generally to analysis of motion objects in water environment. More particularly, the present invention relates to identification of drowning pattern.

### BRIEF SUMMARY

The present invention discloses a dynamic system for identifying and alerting drowning in a pool. The system comprised of: a rail installed within the pool underwater, at least one camera movable along the rail, at least one controller for determining camera movement based on analyzing image captured by said camera, such that the camera viewing area is not distracted, for identifying and alerting drowning pattern by analyzing captured images by said movable camera.

According to some embodiments of the present invention, the rail is designed in a hollow tube having transparent surface at least at the front part of the housing, wherein the camera may be installed on a moving element having a motor and wheels, enabling to move the camera within the tube. Alternatively, said camera may be installed on any other suitable moving means.

Other moving methods may be used such as seen in FIG. 1, where the camera moves along a rail not requiring motor in the moving element 30.

According to some embodiments of the present invention the system further a moving element having a motor and wheels wherein the camera and motor is connected to electrical cable, where at the far end the cable is connected to controller module located outside the water.

According to some embodiments of the present invention the camera and the controller are integrated in one housing of moving element which is movable along the rail.

According to some embodiments of the present invention the controller includes a movement module for controlling the movement of the camera along the rail, wherein the movement control is based on analyzing image captured by the camera and environment condition for identifying distraction or lack of clarity in field of view of the camera.

According to some embodiments of the present invention the analysis of camera movement control includes: during an Idle state or routine movement of the camera, analyzing captured images and environment conditions for identifying distraction or lack of clarity in camera field of view, wherein the Idle state or a routine movement pattern of the camera are determined based on predefined rules in accordance with known schedule and environmental conditions or events.

According to some embodiments of the present invention, once detecting a drowning pattern state, the camera moves to emergency state to track the potential drowning object.

According to some embodiments of the present invention the analyzing include at least on of: identifying concealment in field of view, Identifying reflections in field of view, identifying dazzling in field of view or Identifying unclear images.

According to some embodiments of the present invention in case of distraction in field of view or unclarity, the analyzing module calculates the required direction and distance of moving the camera in order to gain better field of view, wherein based on calculated parameters, are sent control commands to a motor driver, for moving the Camera to a new location or changing routine movement to improve its field of view.

According to some embodiments of the present invention the controller is installed outside the pool connected to the camera via cable.

According to some embodiments of the present invention, the system further comprises a sensor for identifying entrance of leaving body into the pool, wherein upon detection of a living body entering the pool, the system changes status from idle sleeping mode to routine mode.

According to some embodiments of the present invention the tube is elastic and can be installed along a curved wall.

According to some embodiments of the present invention the controller is comprised of a CPU, a memory and RF link for connecting communication network.

According to some embodiments of the present invention the system further comprising a learning calibration module, wherein said module detects distraction pattern, throughout defined time periods and define routine movement/speed/frequency and/or schedule based on detected distraction in defined time periods such that the camera field view of view during the route will avoid, distractions or unclarity.

According to some embodiments of the present invention the calibration process enables to plan the moving or frequency route of the camera based on repeating patterns of environmental conditions such as lighting or behavioral conditions.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a top view diagram of a system components incorporated in a swimming pool, according to some embodiments of the invention;

FIGS. 2A, 2B are flowchart diagrams of analysis of camera movement control, according to some embodiments of the invention; and

FIG. 3 is a flowchart diagram of drowning detection analysis method, according to some embodiments of the invention.

FIG. 4 is a flowchart diagram of Learning/calibration module, according to some embodiments of the invention.

FIGS. 5A, 5B illustrates a perspective view of a tube having inside rail with installed camera, according to some embodiments of the invention.

FIG. 5C illustrates block diagram of the controller, according to some embodiments of the invention.

FIGS. 6A, 6B illustrates a perspective view of the tube with installed camera, according to other embodiments of the invention.

FIG. 7 illustrates a perspective view of two tubes with cameras, installed in rectangular swimming pool, according to some embodiments of the invention.

FIG. 8 is illustrates a perspective view of the two tubes with camera installed in non-rectangular swimming pool having curved side walls, according to some embodiments of the invention.

FIG. 9 illustrates a perspective view of the camera integrated with a controller positioned with a tube, according to some embodiments of the invention.

FIG. 10 illustrates a perspective view of the camera positioned with a tube, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

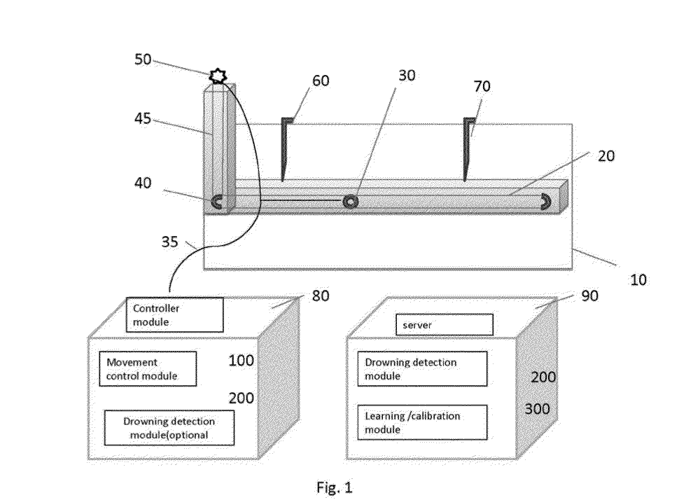

FIG. 1 is a top view diagram of a system components incorporated in a swimming pool, according to some embodiments of the invention. The system according the present invention includes at least camera 30 or a sensor for capturing images or data of objects moving within water reservoir, such as swimming pool 10. The camera is moved along a rail, which is installed on side wall of the pool under water line (optionally above the water). The rail includes a dynamic part which enables to move the camera along the rails. The dynamic part is operated by electrical motor 50, through cable 45. The rail may be anchored to the pool walls by vertical attachment elements 60 and 70.

The camera is connected to a local controller device 80 through network wire 35. The local controller includes a movement control module 100 to determine camera movement for obtaining optimal viewing area. Optionally the controller device includes a Drowning detection module 200. The Drowning detection module may be implemented in a server 90 connected through data network to the controller. Optionally the server may include Learning/calibration module 300 for determining routine motion of the camera.

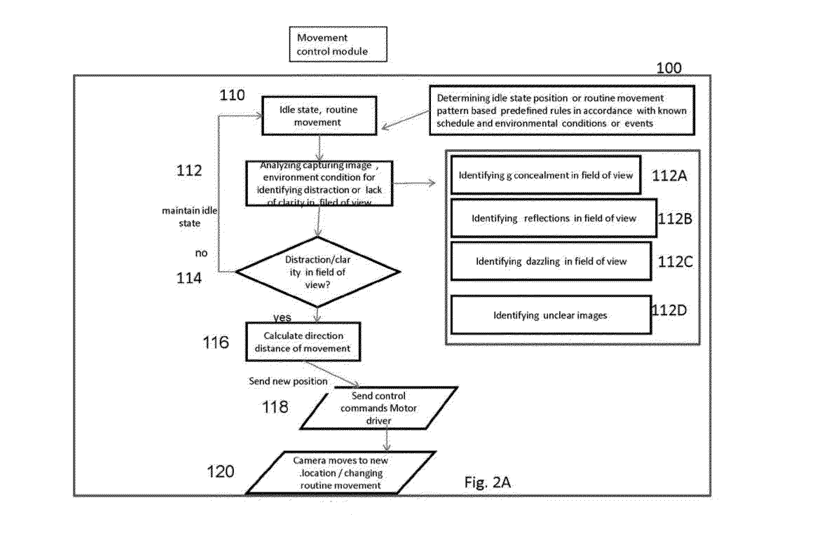

FIG. 2A is a flowchart diagram of analysis of camera movement control, according to some embodiments of the invention. The analysis of camera movement control includes: during idle state or routine movement of the camera 110, analyzing captured images and environment conditions for identifying distraction or lack of clarity in camera field of view 112. The Idle state or a routine movement pattern of the camera may be determined based predefined rules in accordance with known schedule and environmental conditions or events. The analyzing step may include at least one of the following actions, Identifying concealment in field of view 112A, Identifying reflections in field of view 112B, Identifying dazzling in field of view 112C or identifying unclear images 112D.

In case of distraction in field of view or unclarity 114, the module calculates the required direction and distance of moving the camera 116 in order to gain better field of view. Based on calculated parameters, are sent control commands to the Motor driver 118, for moving the Camera to a new location or changing routine movement to improve its field of view 120.

FIG. 2B is a flowchart diagram of analysis of camera movement control, according to some embodiments of the invention. The analysis of camera movement control includes: during Idle state (sleeping mode) of the camera 110A, monitoring pool area to identify a living object entering the pool 113A: if not, remain in idle state, if yes, activate Routine movement state 114A, acquiring, and analyzing images captured by the camera (underwater) 116A. In case of identifying potential drowning state of identified object (118A) (see detection module, change camera movement state to Emergency mode (126A), controlling camera movement to best viewing point in relation to identified drowning body and start tracking said object once the camera reaches in proximity to the object. Optionally accelerating camera motion towards the identified body. The tracking movement path can be determined for obtaining valuable information in relation to the object, such as viewing the object from different angles.

Incase no drowning state is detected, analyzing captured images and environment conditions for identifying concealment, dazzling or unclear image. In case one of these conditions is detected, Calculate direction and distance to improve field of view of the camera 122A for moving camera to a new position, or change the routine movement pattern.

According to some embodiments of the present invention the camera can be tilted in different angle, and optionally apply focus or zoom operations, the controller determines the tilting, zooming or focusing operation based on pre-defined rules and analysis of captured image to obtain an improved field of view or cover dead spots.

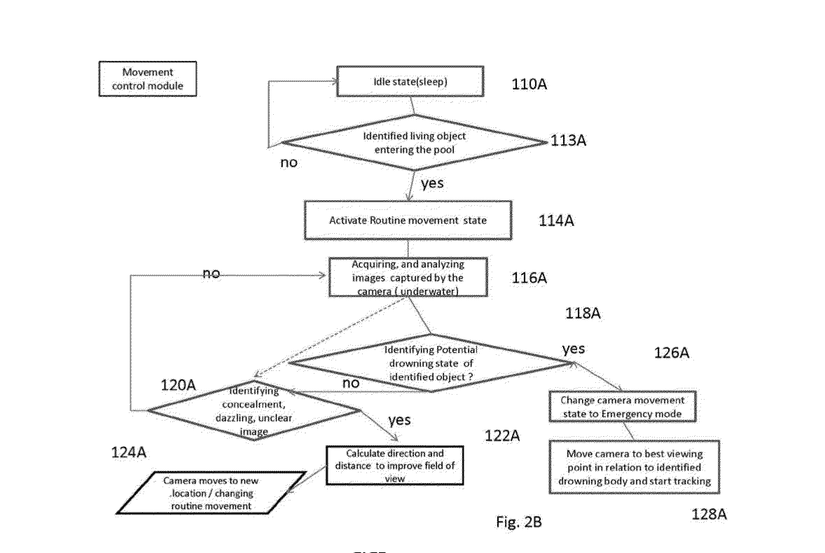

FIG. 3 is a flowchart diagram of drowning detection analysis method, according to some embodiments of the invention. The drowning detection analysis method includes, receiving real time captured images 202. Image processing analysis is applied 204 for detecting submerged objects 206. The submerged object image is analyzed to determine if it's a live body (such as human body) 208, if yes, the position, motion direction and pattern and shape of the detected image is recorded 212. object shape, object position, object consequence moving in x/y axis, and time duration of event

The current captured images are compared to previously recorded image for detecting drowning pattern based on predefined rules 214 analyzing position, motion direction and pattern and shape of object and duration of event. According to other embodiments of the present invention, simultaneously, with the image analysis of object detection, the images are analyzed to detect bubbles 210 in the detected object surrounding, characterized by shape, pattern, and reflections. In case the of identifying drowning pattern 216 and/or identifying bubbles for predefined period 218, the results are analyzed according to predefined rules for determining alert situations 218. In case of alert, an alarm is generated 220 by creating sound or light signal. Optionally an alarm message can be sent through communication module to any communication device, such smart phone.

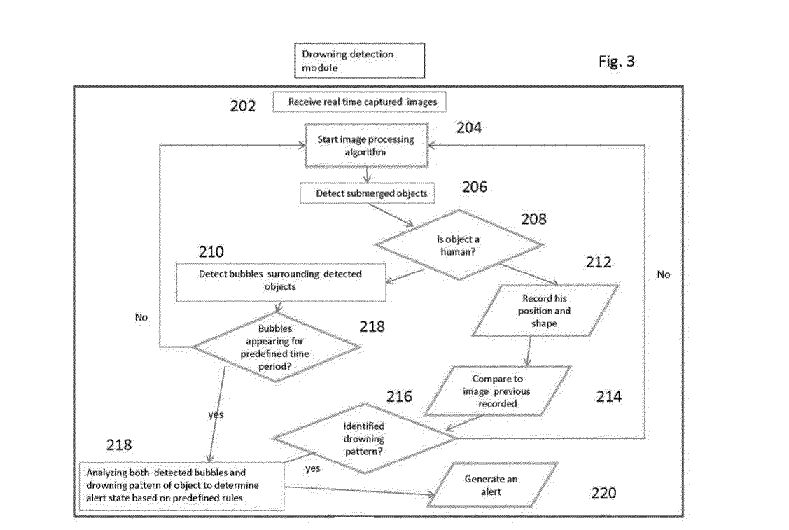

FIG. 4 is a flowchart diagram of Learning/calibration module, according to some embodiments of the invention. The module includes at least one of the following steps: analyzes images of predefined periods 302, detects distraction pattern, throughout defined time periods 304 (e.g. daily, weekly) and define routine movement/speed/frequency and/or schedule based on detected distraction in defined time periods 306: daily or weekly such that the camera field view of view during the route will avoid as much as possible, distractions or unclarity. Such calibration process enables to plan the moving/frequency route of the camera based on repeating patterns of environmental conditions such as lighting or behavioral conditions such number of swimmers at the pool or type of behavior pattern children or adults.

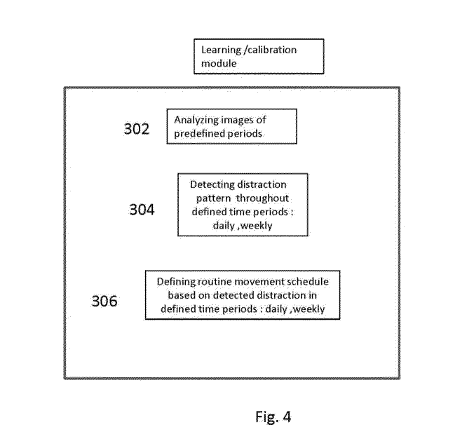

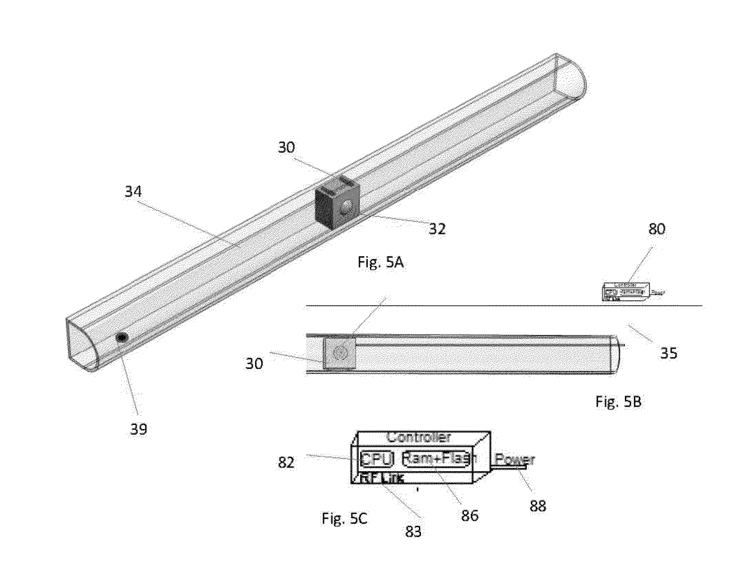

FIGS. 5A, 5B illustrates a perspective view of a tube having inside rail with installed camera, according to some embodiments of the invention. As can be seen in FIGS. 5A and 5B, a sliding element 30 having camera 32 in installed with a tube 34 having transparent cover. The camera is connected via cable 35 to controller 80. The shape of the tube may be designed as half circle to prevent people from standing on it.

FIG. 5C illustrates block diagram of the controller, according to some embodiments of the invention. The controller 80 is comprised of CPU 82 on which comprise movement control module 100 and drowning detection module 200, RAM 84 and Flash memory 86 and power connection 88 to connect to any power source and RF link 83 to connect any communication network. According to this embodiment the controller is installed outside the pool connected by cable 35 to the camera 32 and moving element 30.

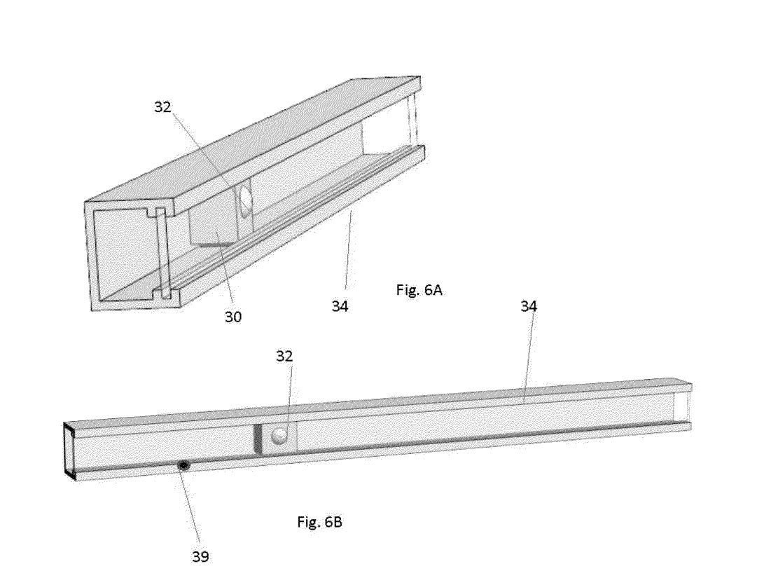

FIGS. 6A, 6B illustrates a perspective view of the tube with installed camera, according to other embodiments of the invention. According to this embodiment the tube has rectangular shape. The camera unit 32 and moving element 30 moves within the rectangular tube 34.

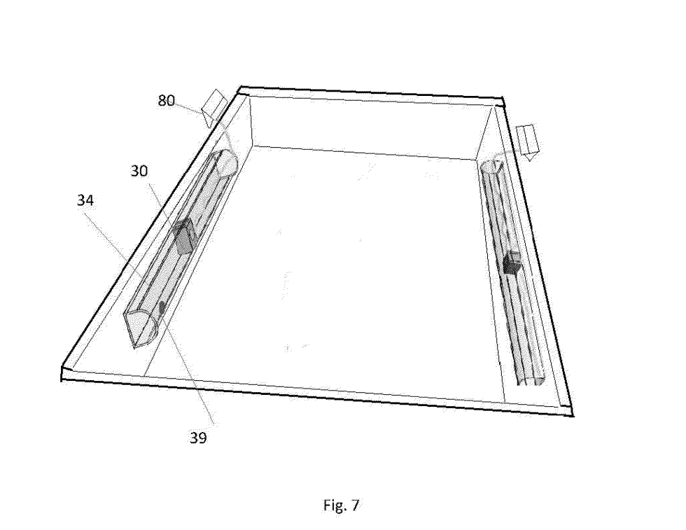

FIG. 7 illustrates a perspective view of two tubes with cameras, installed in rectangular swimming pool, according to some embodiments of the invention. According to this embodiment, two tube camera are each installed along the side walls of the pool. Optionally is installed a detection sensor 39 at the tube for detecting entrance of a living body into the pool. When no living body is presences in the pool the system is in a sleeping mode not operating the cameras or the detection module, once the sensor 39 identifies entrance of a living body of human being or animal into the pool, the system is awaken and the cameras and/or detection module is turned on. The solution of two cameras, each at on side of the pool is essential for crowded pool, or pool which includes obstacle inside the pool such as islands.

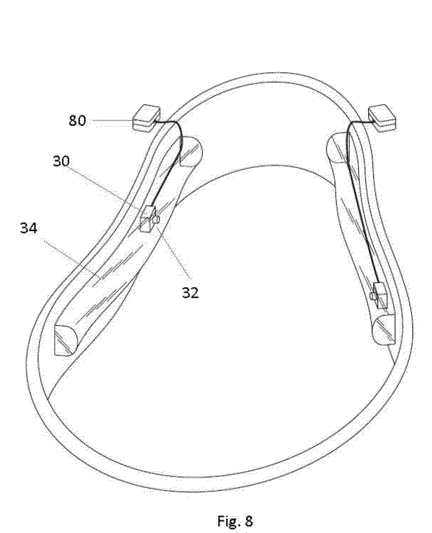

FIG. 8 is illustrates a perspective view of the two tubes with camera installed in non-rectangular swimming pool having curved side walls, according to some embodiments of the invention. According to this embodiment, two tube camera are each installed along the side walls of the pool. The tubes have curved shape adapted to the wall design. According to some embodiments the tube is made of flexible material which can be adjusted to a curved wall of the pool.

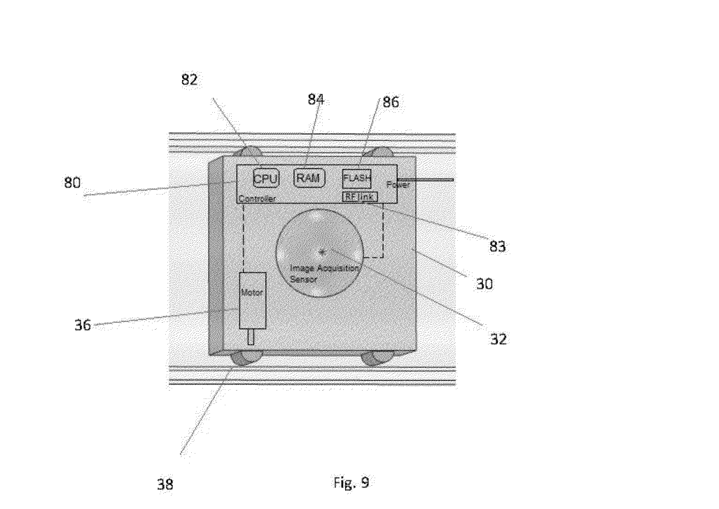

FIG. 9 illustrates a perspective view of the camera integrated with a controller positioned with a tube, according to some embodiments of the invention. According to this embodiment the moving element 30 includes a camera 32, motor 36, wheels 38 and controller 80. The controller 80 is comprised of CPU 82, RAM 84 and flash memory 86 and RF link 83. The CPU comprises movement control module 100 and drowning detection module 200. The motor is controlled by controller 80 to move the moving element 30 with the camera 32 along the tube by rotating wheels 38.

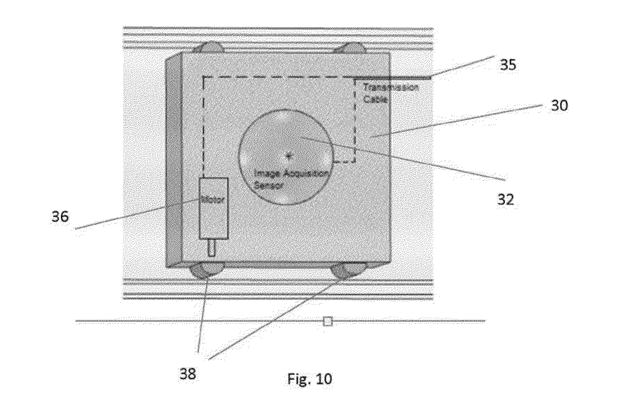

FIG. 10 illustrates a perspective view of the camera positioned with a tube, according to some embodiments of the invention. According to this embodiment the moving element 30 includes a camera 32, motor 36 and wheels 38. The motor is controlled by controller 80 which is installed outside the pool to move the moving element 30 with the camera 32 along the tube by rotating wheels 38.

What is claimed is:

1. A dynamic system for identifying and alerting drowning in a pool, said system comprised of:
a rail installed within the pool underwater;
at least one camera movable along the rail;
at least one controller for determining camera movement based on analyzing image captured by said camera, such that the camera viewing area is not distracted, for identifying and alerting drowning pattern by analyzing captured images by said movable camera.

2. The system of claim 1, wherein the rail is designed in a hollow tube having transparent surface at least at the front part of the housing, wherein the camera is installed on a moving element having a motor and wheels, enabling to move the camera within the tube.

3. The system of claim 1 further a moving element having a motor and wheels wherein the camera and motor is connected to electrical cable, where at the far end the cable is connected to controller module located outside the water.

4. The system of claim 1, wherein the camera and the controller are integrated in one housing of moving element which is movable along the rail.

5. The system of claim 1, wherein the controller includes a movement module for controlling the movement of the camera along the rail, wherein the movement control is based on analyzing image captured by the camera and environment condition for identifying distraction or lack of clarity in field of view of the camera.

6. The system of claim 5, wherein the analysis of camera movement control includes: during an Idle state or routine movement of the camera, analyzing captured images and environment conditions for identifying distraction or lack of clarity in camera field of view, wherein the Idle state or a routine movement pattern of the camera are determined based on predefined rules in accordance with known schedule and environmental conditions or events.

7. The system of claim 1, wherein once detecting a drowning pattern state, the camera moves to emergency state to track the potential drowning object.

8. The system of claim 1, wherein, the analyzing include at least on of:
identifying concealment in field of view, Identifying reflections in field of view, identifying dazzling in field of view or Identifying unclear images.

9. The system of claim 6, wherein in case of distraction in field of view or unclarity, the analyzing module calculates the required direction and distance of moving the camera in order to gain better field of view, wherein based on calculated parameters, are sent control commands to a motor driver, for moving the Camera to a new location or changing routine movement to improve its field of view.

10. The system of claim 1, wherein the controller is installed outside the pool connected to the camera via cable.

11. The system of claim 1 further comprising a sensor for identifying entrance of leaving body into the pool, wherein upon detection of a living body entering the pool, the system changes status from idle sleeping mode to routine mode.

12. The system of claim 2, wherein the tube is elastic and can be installed along a curved wall.

13. The system of claim 1, wherein the controller is comprised of a CPU, a memory and RF link for connecting communication network.

14. The system of claim 1 further comprising a learning calibration module, wherein said module detects distraction pattern, throughout defined time periods and define routine movement/speed/frequency and/or schedule based on detected distraction in defined time periods such that the camera field view of view during the route will avoid, distractions or unclarity.

15. The system of claim 14, wherein the calibration process enables to plan the moving or frequency route of the camera based on repeating patterns of environmental conditions such as lighting or behavioral conditions.

16. The system of claim 1, wherein the camera is tilted in different angle, the controller determines the tilting based on pre-defined rules and analysis of captured image to obtain an improved field of view.

17. The system of claim 1, wherein the controller determines camera focus or zoomed operations based on pre-defined rules and analysis of captured image to obtain an improved field of view.
